(19) United States
(12) Patent Application Publication
(10) Pub. No.: US 2008/0286553 A1
(43) Pub. Date: Nov. 20, 2008

(54) Building Componet and Method of Reinforcing a Building Structure

(75) Inventor: Giovanni Mantegazza, Gorgonzola (MI) (IT)

Correspondence Address: OBLON, SPIVAK, MCCLELLAND MAIER & NEUSTADT, P.C., 1940 DUKE STREET, ALEXANDRIA, VA, 22314, US

(73) Assignee: RUREDIL S.p.A, Milano (IT)

(21) Appl. No.: 12/092,015

(22) PCT Filed: Sep. 6, 2006
(86) PCT No.: PCT/EP2006/066076

§ 371 Date: Apr. 29, 2008

(30) Foreign Application Priority Data
Nov. 11, 2005 (IT) MI2005A002156

(51) Int. Cl. C04B 16/04; D01F 6/74; C04B 20/00; B32B 37/00; B28B 1/14

(52) U.S. Cl. 428/312.4; 524/2; 428/323; 264/299

(57) ABSTRACT

The building component comprises a central structure covered by a layer of cement mortar in which a reinforcement structure formed of poly[benz(1,2-D:5,4-D′)bisoxazole-2,6-diyl-1,4-phenylen] fibre is embedded. The method consists of forming a layer of cement mortar on the structure to be reinforced and embedding in the cement mortar layer a reinforcement structure formed of poly[benz (1,2-D:5,4-D′)bisoxazole-2,6-diyl-1,4-phenylen] fibre. The mortar further comprises unsaturated copolymer resins, fluidifying and thixotropic additives.

The present invention relates to a building component and a method of reinforcing a building structure.

After their installation, building structures (constructed of brick, plain concrete, reinforced concrete, etc.) are known to undergo slow but progressive degradation with the passing of time, caused by environmental aggression or by poor execution and/or by unsuitable choice of materials for that particular application.

Building structures are traditionally reinforced by applying an electrically welded mesh which wraps the structure, in order to increase its ductility.

However, this method presents numerous drawbacks, including installation difficulty caused by the weight and poor manageability of the electrically welded mesh, and the risk of corrosion of the electrically welded mesh, in particular in aggressive environments.

To overcome these drawbacks, a reinforcement system has been developed based on the use of bands and fabrics of carbon or other fibres, which are applied using thermoplastic resin, usually epoxy resin, to ensure adhesion between the building structure and the carbon bands.

However this system has also displayed certain drawbacks, including the insufficient temperature which it is able to withstand; in this respect the temperature is limited to about 80° C. by the presence of the epoxy resins, hence in the case of fire the epoxy resin degrades rapidly and causes the carbon reinforcement bands to separate very quickly from the structure.

Further drawbacks of the use of reinforcement systems with carbon fibres derive from the noxiousness for the operator and the environment by using epoxy resins, the (very high) cost both of the epoxy resins and of the carbon bands, and finally the fact that the epoxy resins create a barrier which prevents thermohygrometric transfer between the building structure and the outside; hence in practice the moisture remains trapped within the building structure and cannot migrate naturally towards the outside.

A further reinforcement system is described in German patent DE A 19525508 which teaches to reinforce a building structure by applying to it a mineral matrix in the form of a layer of cement mortar, then pressing a textile reinforcement mesh thereon to embed it in the cement mortar, and finally applying a second cement mortar layer of the same type as the first layer.

However this reinforcement system presents the considerable drawback of using cement mortar formed from a mixture of cement, fillers and a styrene/acrylate dispersion in water, this latter (the styrene/acrylate dispersion in water) particularly giving the cement mortar a high fluidity which causes it to flow when applied to vertical walls; moreover, the presence of styrene/acrylate causes degradation with the formation of fissures in the dry cement mortar.

To also overcome these drawbacks, EP 1245547 describes a reinforcement system consisting of applying a particular cement mortar to the component to be treated, embedding in this cement mortar layer a mesh of carbon fibres, glass fibres, aramid fibres, polyester, polyethylene or the like, and finally applying a second cement mortar layer onto the first.

In particular, the cement mortar described in said patent enables thermohygrometric transfer between the building component and the outer environment, and presents the same fire resistance as the building structure.

It has been unexpectedly observed that cement mortar of the type indicated in EP 1245547, together with a reinforcement structure formed of poly[benz(1,2-D:5,4-D′)bisoxazole-2,6-diyl-1,4-phenylen] fibre enables mechanical results (in terms of reinforcement) to be obtained (in addition to the advantages indicated in EP 1245547) which are surprisingly better than the other types of reinforcement.

Specifically, said reinforcement structure is formed from a fabric (in which the weft and warp fibres are woven together) or from a mesh (in which the weft and warp fibres are mutually superposed but not woven).

The technical aim of the present invention is therefore to provide a building component and a method of reinforcing a building structure which ensure thermohygrometric transfer between the building structure and the outside, in which the building component presents resistance to fire and to aggressive chemical environments, while at the same time presenting very high mechanical properties (in terms of reinforcement).

The technical aim, together with these and other objects, are attained according to the present invention by a building component and a method of reinforcing a building structure in accordance with the accompanying claims.

Further characteristics and advantages of the invention will be more apparent from the description of a preferred but non-exclusive embodiment of the component and method of the invention given with reference to the accompanying figures, which are provided by way of non-limiting example and in which:

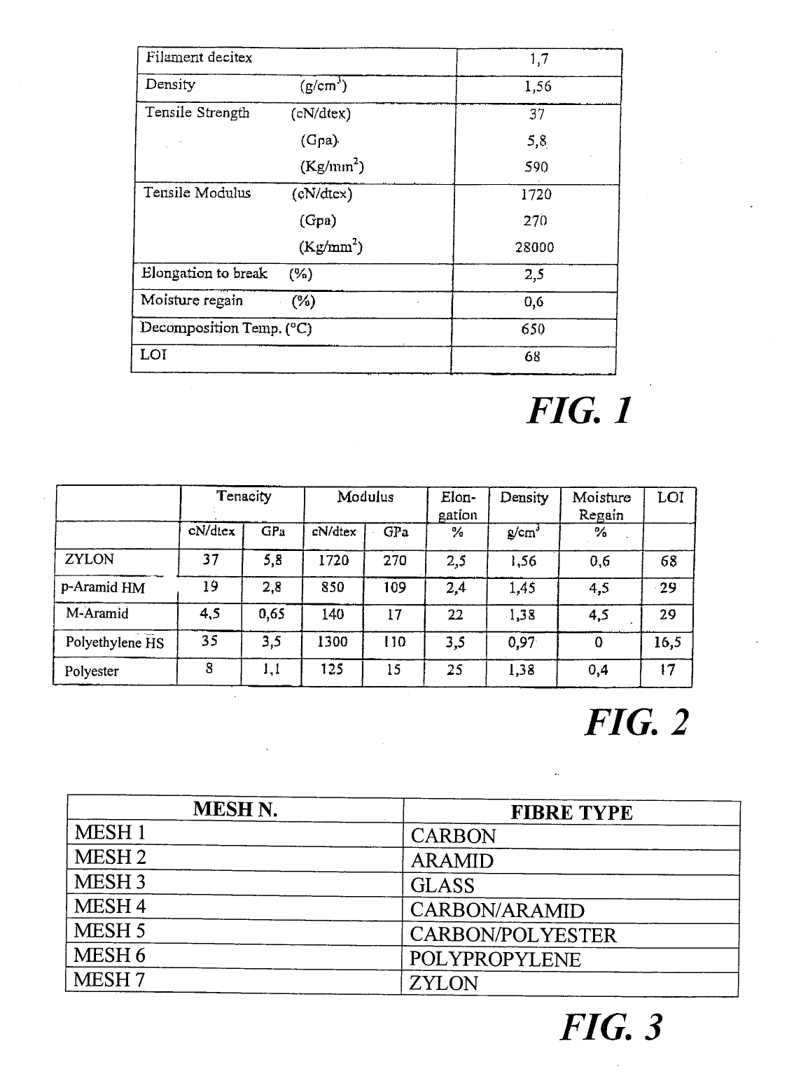

FIG. 1 is a table indicating the mechanical characteristics of poly[benz(1,2-D:5,4-D′)bisoxazole-2,6-diyl-1,4-phenylen] fibres (CAS No. 60857-81-0, marketed under the name “zylon”);

FIG. 2 is a table comparing the mechanical characteristics of poly[benz(1,2-D:5,4-D′)bisoxazole-2,6-diyl-1,4-phenylen] fibres (CAS No. 60857-81-0, marketed under the name “zylon”) with other synthetic fibres;

FIG. 3 is a table indicating the physical nature of the synthetic meshes used in carrying out the flexure tests;

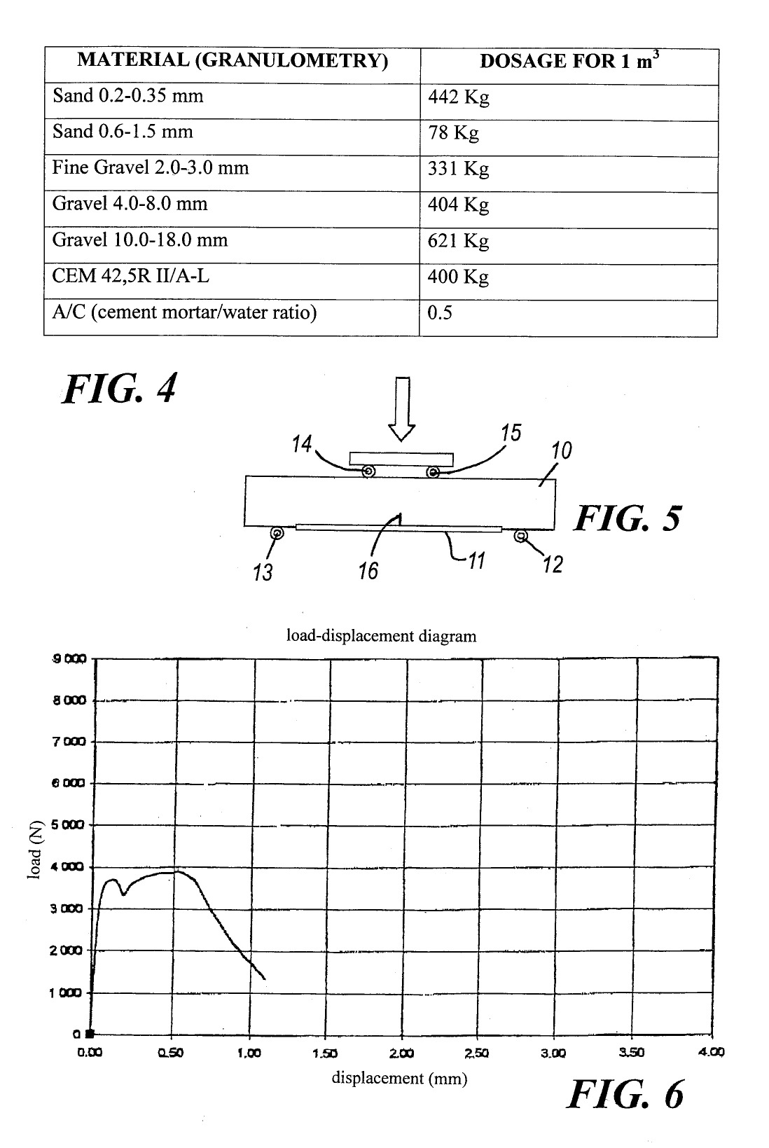

FIG. 4 is a table indicating the concrete mix used to make the test pieces utilized in the flexure tests;

FIG. 5 shows the scheme for reinforcing the concrete test pieces against flexure and for reinforcing them against deformation;

FIG. 6 is a graph showing the load-deflection diagram for test pieces with polypropylene fibre mesh reinforcement;

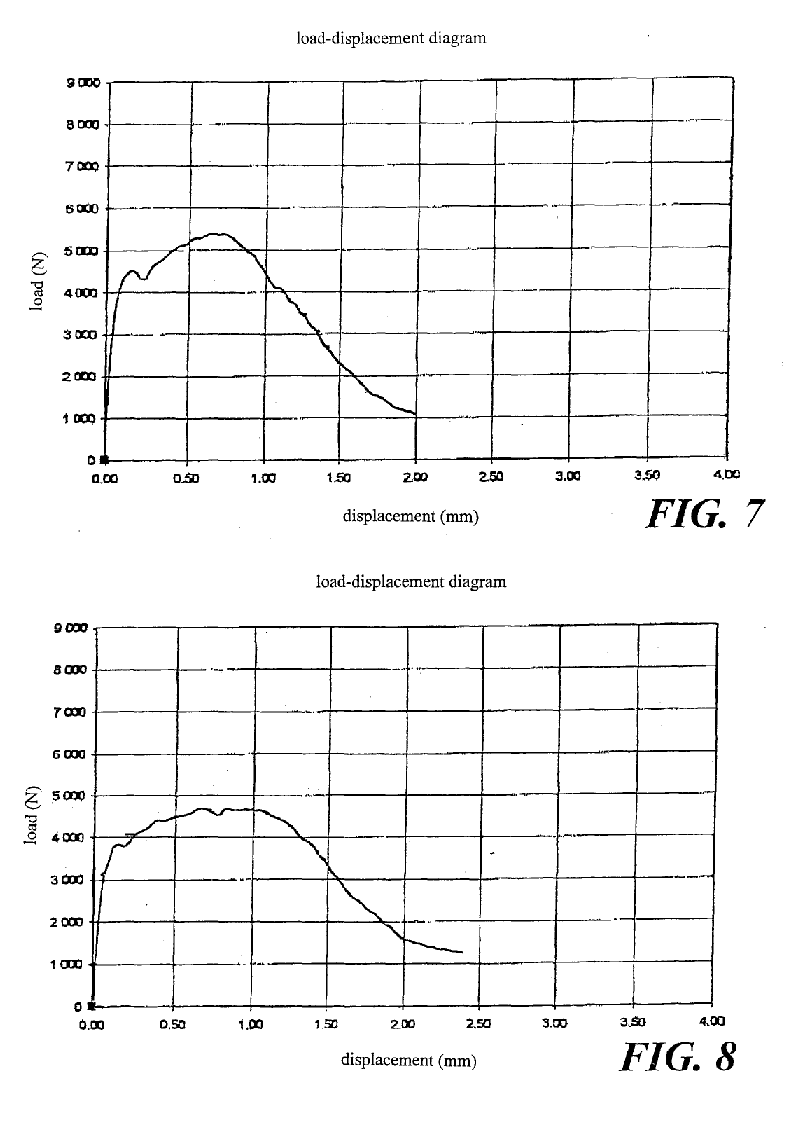

FIG. 7 is a graph showing the load-deflection diagram for test pieces with aramid fibre mesh reinforcement;

FIG. 8 is a graph showing the load-deflection diagram for test pieces with glass fibre mesh reinforcement;

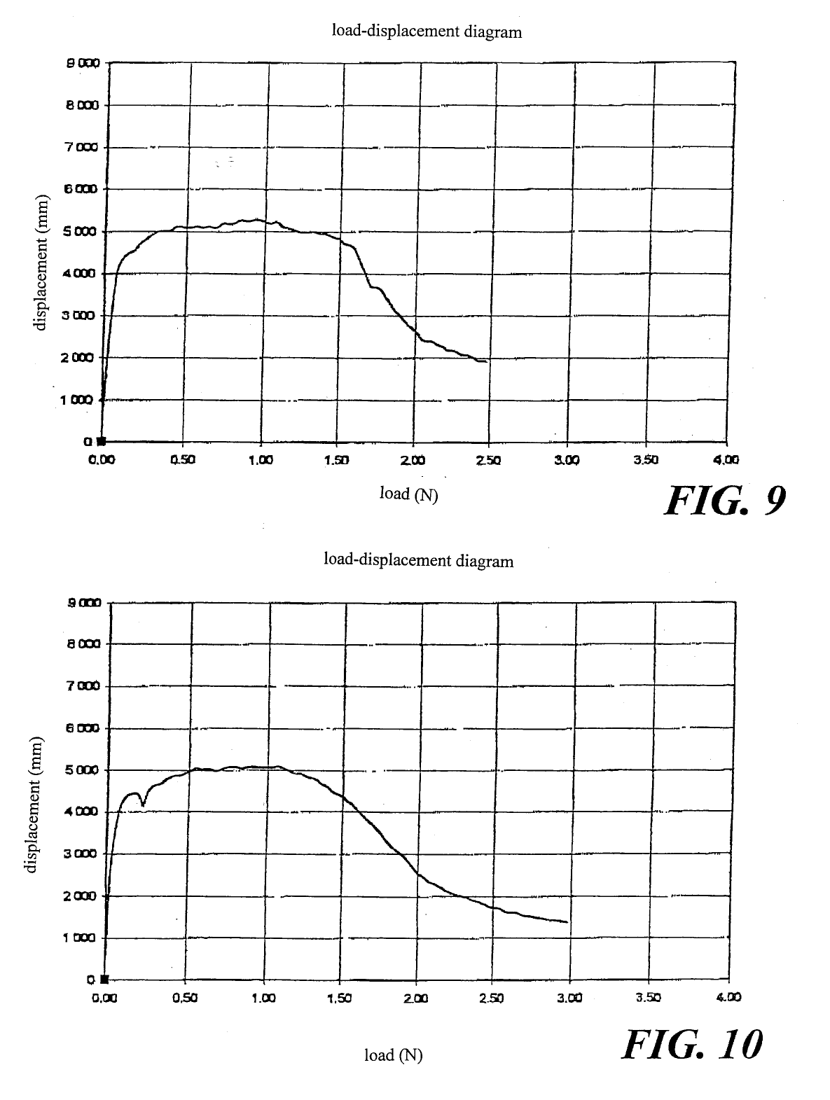

FIG. 9 is a graph showing the load-deflection diagram for test pieces with carbon fibre mesh reinforcement;

FIG. 10 is a graph showing the load-deflection diagram for test pieces with carbon fibre/aramid fibre mesh reinforcement;

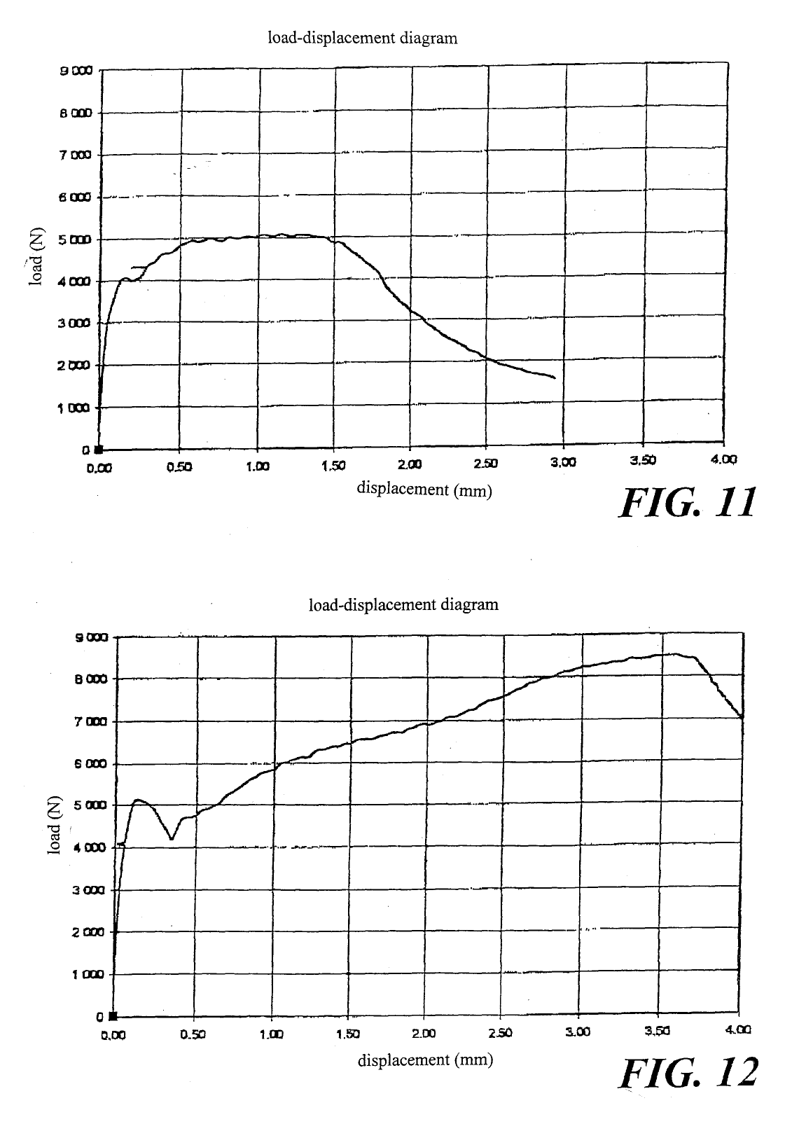

FIG. 11 is a graph showing the load-deflection diagram for test pieces with carbon fibre/polyester fibre mesh reinforcement;

FIG. 12 is a graph showing the load-deflection diagram for test pieces with reinforcement formed from a mesh of poly[benz(1,2-D:5,4-D′)bisoxazole-2,6-diyl-1,4-phenylen] fibres (CAS No. 60857-81-0, marketed under the name “zylon”); and

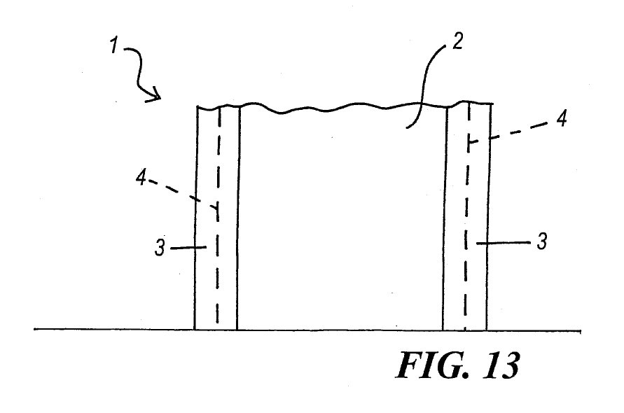

FIG. 13 is a schematic section through a building component of the invention.

With reference to said figures, a building component is shown, indicated overall by the reference numeral 1.

The building component 1 comprises a central structure 2 consisting of the structural element to be reinforced, which may for example be brickwork, plain concrete or reinforced concrete articles.

The central structure 2 is covered with a layer of cement mortar 3; this cement mortar is described specifically in EP 1245547 and comprises between 5% and 95% of cement, between 10% and 70% of fine inert mineral fillers having a particle size less than 700 micron, chemical additives comprising between 0.1% and 25% of unsaturated copolymer resins, between 0.05% and 2.5% of fluidifying additives and between 0.005% and 1% of thixotropic additives pertaining to the cellulose class, all the specified percentages being by weight and referred to the total weight of the cement mortar.

The unsaturated copolymer resins are preferably of acrylic type; the unsaturated copolymer resins and/or the fluidifying additives and/or the thixotropic additives are added to the mortar mix as a liquid mixture or in powder form.

A reinforcement structure 4 in the form of poly[benz(1,2-D:5,4-D′)bisoxazole-2,6-diyl-1,4-phenylen] fibre (CAS No. 60857-81-0) is embedded in the interior of the cement mortar layer 3, the reinforcement structure 4 being formed in particular from the poly[benz(1,2-D:5,4-D′)bisoxazole-2,6-diyl-1,4-phenylen] fibre produced by the Toyobo Company under the commercial name of “zylon”; the mechanical characteristics of this fibre are indicated in FIG. 1.

Preferably the reinforcement structure is a textile structure or a mesh structure, the characteristics of which are preferably those indicated in EP 1245547.

The fluidifying additives for the cement mortar (these also being specifically described in EP 1245547) are chosen from the group consisting of polymers based on polycondensed lignin, betanaphthalene or melamine-formaldehyde sulphonates, and those based on modified polyacrylate chains.

Mechanical deformation load tests were carried out on concrete test pieces of dimensions 600×150×75 millimetres reinforced against flexure by the reinforcement system indicated in EP 1245547; synthetic meshes of different types were used, among which the zylon fibre, the chemical mesh nature and the mechanical characteristics of the fibres used for the tests are indicated in FIGS. 3 and 2 respectively.

The mix design of the concrete used for forming the test pieces was the same for all test pieces, and consisted of the mix indicated in the table of FIG. 4.

With reference to FIG. 5, the concrete test pieces were reinforced with a reinforcement structure 11 and were subjected to a flexure test at four points 12, 13, 14, 15, the load and deflection being measured at the centre line.

The test was conducted with controlled displacement at a test velocity of 0.01 millimetres/minute and with a load cell of 50 kN maximum capacity.

The test pieces were notched on their centre line (at 16) at the intrados, with a notch of 1 centimetre depth.

For each type of synthetic mesh, 25 test pieces reinforced as indicated in FIG. 5 were prepared, each test piece being subjected to a flexure test at four points with the load and deflection being measured at the centre line.

The test results are shown in FIGS. 6-12.

Specifically:

the concrete test pieces reinforced against flexure with polypropylene fibre mesh (FIG. 6) showed that the polypropylene fibre had almost no capacity to ensure an increase in maximum load, and consequently were unable to form an effective structural reinforcement;

the concrete test pieces reinforced against flexure with aramid fibre mesh (FIG. 7) or with glass fibre mesh (FIG. 8) showed a slight increase in maximum load, however the fibre, by unthreading from the matrix, rapidly loses its effectiveness, as shown by the descending branch of the curve;

the concrete test pieces reinforced against flexure with carbon fibre mesh (FIG. 9) or with a mixed carbon and aramid fibre mesh (FIG. 10) or with a mixed carbon and polyester fibre mesh (FIG. 11) proved to be the most effective compared with the previously tested reinforcements. In this respect, the pattern of the load/displacement curve shows an increase in maximum load and ductile behaviour of crisis type (slow descent of the second branch of the curve).

the concrete test pieces reinforced against flexure with zylon fibre mesh (FIG. 12) present (as shown in the figure) a load which increases to a value double that of carbon reinforcement, to considerably increase the reinforcement ductility, as can be deduced by the area subtended by the corresponding curve.

The present invention also relates to a method of reinforcing a building structure.

The method consists of forming on the building structure to be reinforced a layer of covering cement mortar of the aforestated type, and embedding in the cement mortar layer a reinforcement structure formed of poly[benz(1,2-D:5,4-D′)bisoxazole-2,6-diyl-1,4-phenylen] fibre (of CAS No. 60857-81-0).

The reinforcement structure is suitably a mesh structure.

It has been found in practice that the building component and the method of reinforcing a building structure of the invention are particularly advantageous as they enable reinforcements for damaged structures to be formed having superior mechanical characteristics while at the same time enabling thermohygrometric transfer between the structure and the outside and ensuring resistance even under extreme conditions such as the presence of fire or aggressive environments.

The building component and the method of reinforcing a building structure conceived in this manner are susceptible to numerous modifications and variants, all failing within the scope of the inventive concept; moreover all details can be replaced by technically equivalent elements.

In practice the materials used and the dimensions can be chosen at will according to requirements and to the state of the art.

1. A building component comprising a central structure covered by a layer of cement mortar comprising from 5% to 95% of cement, from 10% to 70% of fine inert mineral fillers having a particle size less than 700 microns, chemical additives comprising from 0.1% to 25% of unsaturated copolymer resins, from 0.05% to 2.5% of fluidifying additives and from 0.005% to 1% of thixotropic additives pertaining to the cellulose class, wherein all the specified percentages are by weight and referred to the total weight of the cement mortar, and a reinforcement structure embedded in the cement mortar layer, wherein said reinforcement structure is formed of poly[benz(1,2-D:5,4-D′)bisoxazole-2,6-diyl-1,4-phenylen] fibre.

2. The building component as claimed in claim 1, wherein at least one of said unsaturated copolymer resins, said fluidifying additives, said thixotropic additives, or combinations thereof are added to the mortar mix as a liquid mixture or in powder form.

3. The building component as claimed in claim 1, wherein said poly[benz(1,2-D:5,4-D′)bisoxazole-2,6-diyl-1,4-phenylen] fibre has the CAS No. 60857-81-0.

4. The building component as claimed in claim 1, wherein said reinforcement structure is a textile structure.

5. The building component as claimed in claim 1, wherein said reinforcement structure is a mesh.

6. The building component as claimed in claim 1, wherein said fluidifying additives are selected from the group consisting of a polymer based on polycondensed lignin, a polymer based on betanaphthalene, a polymer based on melamine-formaldehyde sulphonates, and a polymer based on modified polyacrylate chains.

7. A method of reinforcing a building structure, comprising forming on the building structure to be reinforced a layer of covering cement mortar comprising from 5% to 95% of cement, from 10% to 70% of fine inert mineral fillers having a particle size less than 700 microns, chemical additives comprising from 0.1% to 25% of unsaturated copolymer resins, from 0.05% to 2.5% of fluidifying additives and from 0.005% to 1% of thixotropic additives pertaining to the cellulose class, wherein all the specified percentages are by weight and referred to the total weight of the cement mortar, and embedding a reinforcement structure in the cement mortar layer, wherein the reinforcement structure is formed of poly[benz(1,2-D:5,4-D′)bisoxazole-2,6-diyl-1,4-phenylen] fibre.

8. The method as claimed in claim 7, wherein at least one of said unsaturated copolymer resins, said fluidifying additives, said thixotropic additives, or combinations thereof are added to the mortar mix as a liquid mixture or in powder form.

9. The method as claimed in claim 7, wherein said poly[benz(1,2-D:5,4-D′)bisoxazole-2,6-diyl-1,4-phenylen] fibre has the CAS No. 60857-81-0.

10. The method as claimed in claim 7, wherein said reinforcement structure is a textile structure.

11. The method as claimed in claim 7, wherein said reinforcement structure is a mesh.

12. The method as claimed in claim 7, wherein said fluidifying additives are selected from the group consisting of a polymer based on polycondensed lignin, a polymer based on betanaphthalene, a polymer based on melamine-formaldehyde sulphonates, and a polymer based on modified polyacrylate chains.

13. A method for reinforcing a structure comprising embedding a poly[benz(1,2-D:5,4-D′)bisoxazole-2,6-diyl-1,4-phenylen] fibre into the structure formed with a cement mortar comprising from 5% to 95% of cement, from 10% to 70% of fine inert mineral fillers having a particle size less than 700 microns, chemical additives comprising from 0.1% to 25% of unsaturated copolymer resins, from 0.05% to 2.5% of fluidifying additives and from 0.005% to 1% of thixotropic additives pertaining to the cellulose class, wherein all the specified percentages are by weight and referred to the total weight of the cement mortar.

14. The method as claimed in claim 13, wherein at least one of said unsaturated copolymer resins, said fluidifying additives, said thixotropic additives, or combinations thereof are added to the mortar mix as a liquid mixture or in powder form.

15. The method as claimed in claim 13, wherein said poly[benz(1,2-D:5,4-D′)bisoxazole-2,6-diyl-1,4-phenylen] fibre has the CAS No. 60857-81-0.
